(19) United States
(12) Patent Application Publication
(10) Pub. No.: US 2006/0230009 A1
(43) Pub. Date: Oct. 12, 2006

(54) System for the automatic categorization of documents

(76) Inventor: Randall Wade McNeely, Arlington, TX (US)

Correspondence Address: IBM CORPORATION (RUS);c/o Rudolf O Siegesmund Gordon & Rees, LLp, 2100 Ross Avenue, Suite 2600, DALLAS, TX, 75201, US

(21) Appl. No.: 11/104,314

(22) Filed: Apr. 12, 2005

(51) Int. Cl. G06N 5/00

(52) U.S. Cl. 706/45

(57) ABSTRACT

The invention is an improved file retrieval and organization system, comprising a computer-implemented method of mapping files in a file space, and of locating files according to dynamic search functions. The invention further includes an interface through which a user controls the parameters of the dynamic search functions. The parameters include file attributes, which can be simple attributes, such as a file's size, or complex attributes, such as a file's subject. The interface also allows a user to select a reference file or assign specific values to selected attributes, and the system will organize all files according to their proximity in the file space to the reference file or assigned values.

### FIELD OF THE INVENTION

The invention relates generally to data processing apparatus and corresponding methods for the retrieval of data stored as computer files, including means or steps for organizing and inter-relating data or files.

### BACKGROUND OF THE INVENTION

Without doubt, the advent of computerized data processing machines, especially the personal computer, revolutionized the way that information is organized and managed. Perhaps the most fundamental method of organizing information in such a data processing machine is storing related information in a digital “file,” and storing related files in a hierarchical folder structure (also commonly known as a directory structure). A “file,” as that term is used here, refers to any collection of information that is named and stored as a logical unit. Of course, this basic organizational scheme requires manual steps of storing or moving files into the appropriate folder.

The basic method described above is useful for managing and organizing limited numbers of digital documents, but becomes less practical as the number and complexity of documents increase. Naturally, more sophisticated file organization and retrieval techniques have evolved along with the evolution of data processing machines generally. Some software applications, for example, provide a means for selectively retrieving files based upon certain attributes of the files. This method, referred to here generally as the “filter” method, retrieves or accesses files only if the files have attributes that match given values. File attributes generally can be classified as internal or external, where internal attributes include inherent physical properties such as size or creation date, and external attributes include “metadata” such as the author or subject. Another common file retrieval method, referred to here generally as the “keyword” method, is searching files for certain words, phrases, or strings of data in a file, and retrieving only files that include those words, phrases, or strings of data.

In U.S. Pat. No. 6,397,205 (issued May 28, 2002), Juola describes some of these more sophisticated techniques in detail, and discloses yet another interesting method based upon file “entropy.” As Juola explains, “Known document retrieval and filtering systems generally hinge upon the ability of the system to gauge accurately how relevant and useful a selected document is to, for example, a previous document or an established category.”

Many systems, such as those disclosed and described by Juola, provide unique approaches to the problem of retrieving only the most relevant files. “Relevance,” though, is subject to a wide variety of user interpretations, and the systems that attempt to solve the problem are as varied as these interpretations. Moreover, no known system provides an effective means for dynamically organizing files without prior knowledge of the files' contents. Thus, there is still a general need for improved, comprehensive file retrieval and organization systems that can “gauge accurately how relevant and useful” a file is to any given reference point.

### SUMMARY OF THE INVENTION

The invention described in detail below is an improved file retrieval and organization system, comprising a computer-implemented method of mapping files in a file space, and of locating files according to dynamic search functions. The invention further includes an interface through which a user controls the parameters of the dynamic search functions. The parameters include file attributes, which can be simple attributes, such as a file's size, or complex attributes, such as a file's subject. The interface also allows a user to select a reference file or assign specific values to selected attributes, and the system will organize all files according to their proximity in the file space to the reference file or assigned values.

In an alternative embodiment, the invention includes a system of analyzing files to create dynamic file categories based on clusters in the file space, without any user intervention. This embodiment allows a user to quickly organize a large set of files without any particular knowledge of the files' contents.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is a schematic of an exemplary network of hardware devices;

FIG. 2 is a schematic of a memory having the components of the present invention stored therein;

FIG. 3 is an exemplary array of computer file attributes associated with the invention;

FIG. 4 is a flowchart of the file manager program associated with the present invention; and

FIG. 5 represents an exemplary two-dimensional space in which the exemplary computer file attributes of FIG. 3 is mapped.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “file manager program.”

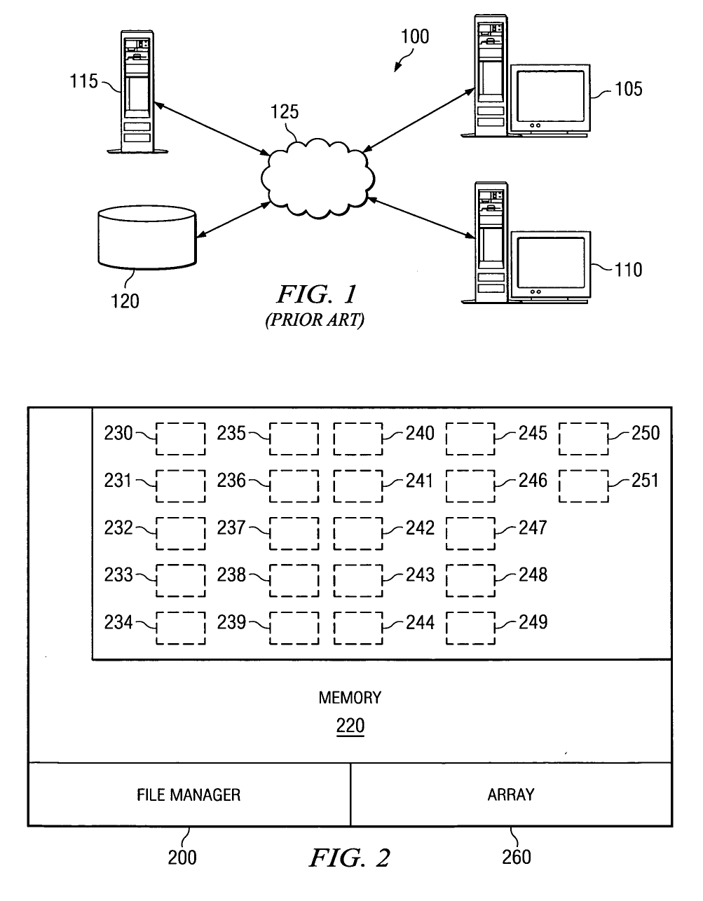

Additionally, the file manger program is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

File manager program 200 typically is stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media, and any constituent component of memory 220 may physically reside in any node or combination of nodes in exemplary network 100. Thus, FIG. 2 is included merely as a descriptive expedient and does not necessarily reflect any particular physical embodiment of memory 220. As depicted in FIG. 2, though, memory 220 may include additional data and programs. Of particular import to file manager program 200, memory 220 may include data organized as computer files 230-251, and array 260, with which file manager program 200 interacts.

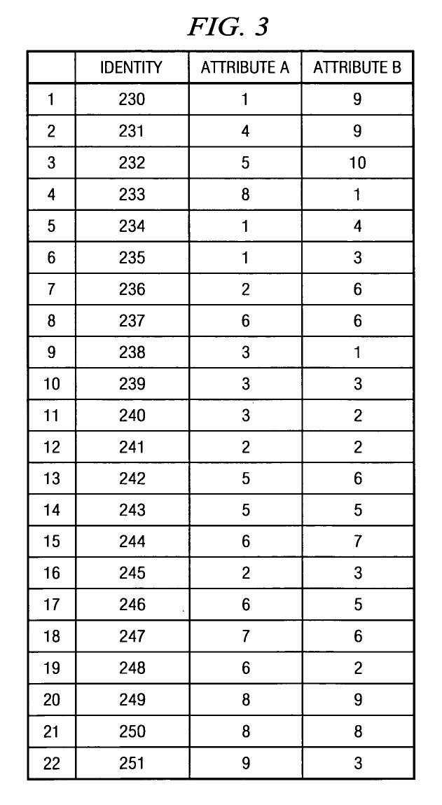

A primary function of file manager program 200 is to retrieve “relevant” information from data stored as a set of computer files, such as exemplary computer files 230-251 (see FIG. 2). In this context, “relevance” is proportional to the similarity of computer file attributes to any given set of reference attributes. Thus, file manager program 200 operates on computer files that have quantifiable attributes such as size, author, or subject. Computer files 230-251 are representative of such files having quantifiable attributes A and B. All computer files also have a unique identity that distinguishes one computer file from another. For purposes of the following discussion, it is assumed that each computer file has an identity that comprises, at a minimum, a unique name. The identity may further comprise a specific location, or “path,” if necessary to distinguish a specific computer file. File manager program 200 stores the identity and attributes of each computer file 230-251 as an element in an array, such as array 260 in memory 220. Thus, if exemplary computer files 230-251 are stored in array 260, array 260 would comprise an array having dimensions of twenty-two elements by three elements, representing twenty-two files having two attributes and an identity. FIG. 3 represents an exemplary array 260 of computer files 230-251. FIG. 3 includes row and column headings, which are not material to array 260 and are provided for illustrative purposes only. Although an array is used to facilitate the description herein, those skilled in the art will be aware of other data structures that are suitable for storing the identities and attributes, including object-oriented structures and database files.

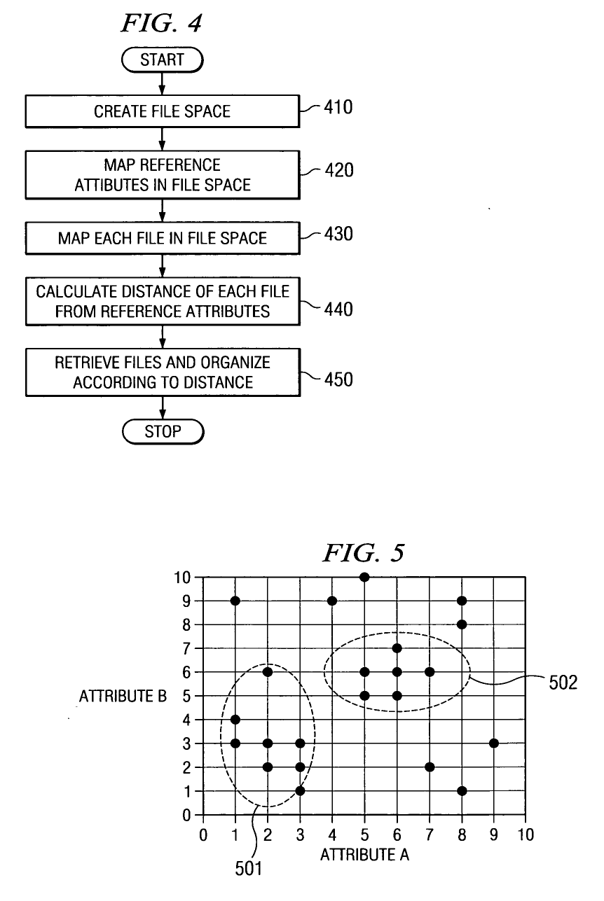

An overview of file manager program 200 is provided in the flowchart of FIG. 4, which is referenced for illustration in the following description. As noted above, the relevance of a computer file is proportional to the similarity of the computer file's attributes to a given set of reference attributes. To evaluate the similarity of multiple attributes of multiple computer files to the reference attributes, file manager program 200 first creates a virtual “file space” (410), wherein the file space has a number of dimensions equal to the number of reference attributes. File manager program 200 then maps the reference attributes as a single reference point in the file space (420), the reference point comprising ordinates representative of the reference attribute values. Similarly, file manager program also maps each computer file as a single datum point in the file space (430), wherein each point comprises ordinates representative of each computer file's attribute values. FIG. 5 illustrates the results of this mapping for the exemplary case of computer files 230-251, in which each file has only two attributes and, thus, the file space is only two-dimensional. This example is limited to two attributes for the sake of visual simplicity, but the principles are readily extensible to file spaces of any dimension. File manager program 200 then calculates the “distance” between the reference point and each mapped datum point (440). The premise behind the distance calculation is that the similarity of any group of attributes is directly proportional to their proximity in the file space. Accordingly, the relevance of a computer file represented by a datum point in the file space should be inversely proportional to the distance between the datum point and the reference point. In the simple two-dimensional example of FIG. 5, calculating the distance between the reference point and any datum point is a simple matter of subtracting two vectors representing the reference point and the datum point in the file space, or applying Pythagoras's well-known theorem to calculate the hypotenuse of a triangle. Other mathematical functions are readily available to those skilled in the art and applicable to file spaces of higher dimensions. File manager program 200 then retrieves the identities of each computer file and organizes them according to their respective distances from the reference point (450). In the preferred embodiment, file manager program 200 displays the computer files that are so organized to a user, so that the user can select and retrieve a specific computer file from the display. The map of any file space optionally can be stored in a memory, such as memory 220, which can be subsequently retrieved for improved processing time. If a map is stored in such a memory, then file manager program 200 generally adds and removes computer files to the map in real-time, as computer files are created and destroyed.

Several alternative modes of obtaining reference attributes for use in file manager program 200 are contemplated. In a first mode, a user of file manager program 200 selects one or more attributes and assigns specific values to those attributes. In a second mode, a user selects a specific computer file and the attributes of the selected file become the reference attributes. In a variation of the second mode, the user selects a specific computer file and specific attributes of that computer file, and only the attributes specifically selected become the reference attributes. In a third mode, file manager program 200 maps the computer files, as described above, identifies densely populated areas of the map, identifies a point in or around the center of a densely populated area, and sets the reference attributes equal to the identified point. This third mode allows a user to quickly organize a large set of computer files without any particular knowledge of the computer files' contents.

Several modes of refining the operation of file manager program 200 also are contemplated. Specifically, in a first mode, file manager program 200 is modified so that only computer files that are within a given distance of the reference point are identified. The given distance, referred to here as the “maximum distance parameter,” may be specified by a user at run-time, or a default value may be integrated into the program. In a second mode, which can operate independently or in conjunction with the maximum distance parameter, file manager program 200 is modified so that only computer files within a given subspace boundary of the file space are retrieved. FIG. 5 illustrates two subspace boundaries that limit the results of file manager program 200. Boundary 501, for example, represents an elliptical function that is weighted to favor attribute B, while boundary 502 is a circular function that gives attributes A and B equal weight.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer-implemented method for retrieving data stored as computer files having one or more attributes, the method comprising:
mapping the computer files as data points in a file space, the file space having a number of dimensions equal to the number of attributes;
providing a reference point in the file space;
calculating the distance between the reference point and each data point; and
displaying the identity and distance from the reference point of each computer file in the file space.

2. The method of claim 1 further comprising:
providing a maximum distance parameter; and
wherein the displaying step only displays the identity of a computer file if the distance between the reference point and the data point associated with the computer file is less than the maximum distance parameter.

3. The method of claim 2 further comprising:
defining a subspace boundary within the file space; and
wherein the distance between the reference point and each computer file is calculated and the computer file identity displayed only if the data point associated with the computer file is within the subspace boundary.

4. The method of claim 3 further comprising sorting the computer files by distance before displaying the identity of each computer file within the subspace boundary.

5. The method of claim 4 wherein the file space is an array.

6. The method of claim 5 further comprising storing the array in a memory for subsequent retrieval.

7. The method of claim 6 further comprising:
adding a new computer file to the file space when the new computer file is created; and
deleting a computer file from the file space when the computer file is destroyed.

8. A system for retrieving and organizing data stored as computer files having one or more attributes, the system comprising:
a mapping means for mapping the computer files in a file space;
an input means for setting a reference point in the file space;
a processing means for calculating the distance between the reference point and each computer file in the file space; and
a reporting means for identifying each computer file in the file space and for indicating each computer file's relative distance from the reference point in the file space.

9. A computer-readable medium having computer-executable instructions for performing a method of retrieving and organizing data stored as computer files having one or more attributes, wherein the method comprises:
mapping the computer files as data points in a file space, the file space having a number of dimensions equal to the number of attributes;
providing a reference point in the file space;
calculating the distance between the reference point and each data point; and
displaying the identity and distance from the reference point of each computer file in the file space.

10. The computer-readable medium of claim 9 wherein the method further comprises: providing a maximum distance parameter; and
wherein the displaying step only displays the identity of a computer file if the distance between the reference point and the data point associated with the computer file is less than the maximum distance parameter.

11. The computer-readable medium of claim 10 wherein the method further comprises:
defining a subspace boundary within the file space; and
wherein the distance between the reference point and each computer file is calculated and the computer file identity displayed only if the data point associated with the computer file is within the subspace boundary.

12. The computer-readable medium of claim 11 wherein the method further comprises sorting the computer files by distance before displaying the identity of each computer file within the subspace boundary.

13. The computer-readable medium of claim 12 wherein the file space is an array.

14. The computer-readable medium of claim 13 wherein the method further comprises storing the array in a memory for subsequent retrieval.

15. The computer-readable medium of claim 14 wherein the method further comprises:
adding a new computer file to the file space when the new computer file is created; and
deleting a computer file from the file space when the computer file is destroyed.
